(19) United States
(12) Patent Application Publication
(10) Pub. No.: US 2009/0069977 A1
(43) Pub. Date: Mar. 12, 2009

(54) APPARATUS AND METHODS FOR AUTOMATICALLY ACTIVATING A MOTOR VEHICLE TURN SIGNAL LAMP

(75) Inventor: CRAIG R. MARKYVECH, ROMULUS, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/854,344

(22) Filed: Sep. 12, 2007

(51) Int. Cl. G01C 21/34; G06F 17/00; G06F 17/40

(52) U.S. Cl. 701/41; 701/76

(57) ABSTRACT

Motor vehicles and methods are provided for automatically activating a motor vehicle turn signal. One motor vehicle includes a navigation system configured to determine a route to a destination, the route having a turn. The navigation system is also configured to monitor a present location of the motor vehicle and automatically activate a turn signal when the motor vehicle approaches the turn. A navigation system includes means for receiving a destination from a user, means for generating a route to the destination, the route having a turn, and means for activating the turn signal. The activating means is configured to automatically activate the turn signal when the motor vehicle approaches the turn. One method includes determining a motor vehicle route to a destination, the destination having a turn, monitoring the present location of the motor vehicle, and automatically activating a turn signal when the motor vehicle approaches the turn.

### TECHNICAL FIELD

The present invention generally relates to motor vehicles, and more particularly relates to apparatus and methods for automatically activating a motor vehicle turn signal lamp prior to the motor vehicle reaching a turn.

### BACKGROUND OF THE INVENTION

Many motor vehicles include a turn-by-turn navigation system designed to guide the user to a predetermined destination. The user typically inputs a starting point and a destination or just a destination, and the navigation system calculates a route from the starting point to the destination or from the motor vehicle's current location to the destination. As the user navigates along the calculated route, the navigation system provides visual and/or audible instructions.

For example, the vast majority of routes include one or more turns that the user must make. Prior to reaching a turn, contemporary navigation systems typically visually and/or audibly instruct the user to “turn left” or “turn right” as the user approaches a turn. However, if the user has muted the sound of the navigation system or is not paying enough attention to the visual and/or audible instructions, the user may miss a turn. Moreover, if the user is paying too much attention to the instructions and/or surrounding environment (e.g., traffic conditions, obstacles, etc.), the user may fail to properly activate a turn signal lamp of his/her motor vehicle. Specifically, the user may fail to activate the turn signal lamp at a safe distance (or a distance prescribed by law) prior to the turn, or may fail to activate the turn signal lamp altogether.

Accordingly, it is desirable to provide apparatus and methods for automatically activating a motor vehicle turn signal lamp prior to the motor vehicle reaching a turn. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

Various exemplary embodiments of the invention provide a motor vehicle comprising a turn signal lamp and a navigation system coupled to the turn signal lamp. The navigation system is configured to determine a route to a destination, the route having a turn. The navigation system is also configured to monitor the present position of the motor vehicle and automatically activate the turn signal when the motor vehicle approaches the turn.

Other exemplary embodiments provide navigation systems configured to be coupled to a motor vehicle turn signal lamp. One navigation system comprises means for receiving a destination from a user and means for generating a route to the destination, the route having a turn. The navigation system also comprises means for activating the turn signal lamp coupled to the generating means, the activating means configured to automatically activate the turn signal lamp when the motor vehicle approaches the turn.

Methods for automatically activating a turn signal lamp on a motor vehicle are also provided. One method comprises the step of determining a route to a destination, the route having a turn, and monitoring a present location of the motor vehicle as the motor vehicle navigates the route. The method also comprises the step of automatically activating the turn signal when the motor vehicle approaches the turn.

### DESCRIPTION OF THE DRAWINGS

The present invention will hereinafter be described in conjunction with the following drawing figures, wherein like numerals denote like elements, and

FIG. 1 is a schematic diagram illustrating a top view of a motor vehicle comprising one exemplary embodiment of a system for automatically activating a turn signal lamp of the motor vehicle; and

FIG. 2 is a flow diagram of one exemplary embodiment of a method for automatically activating a turn signal lamp of the motor vehicle of FIG. 1.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

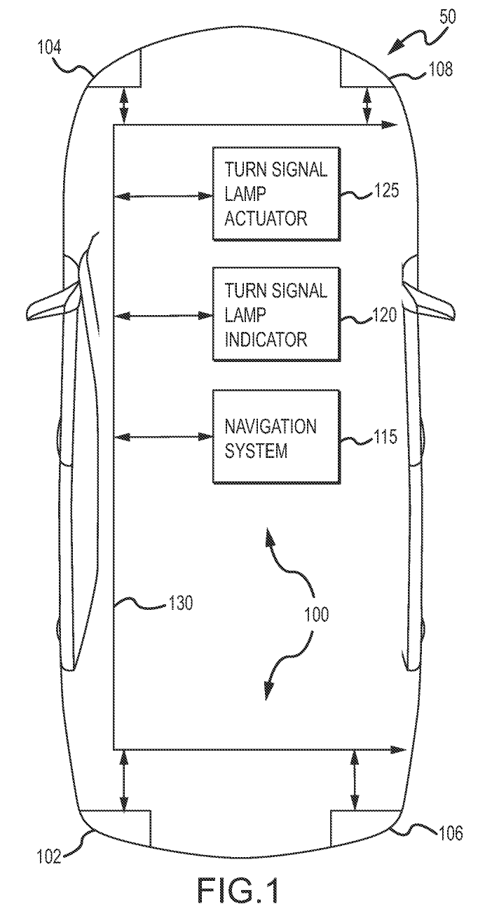

FIG. 1 is a schematic diagram of a motor vehicle 50 including a system 100 for automatically activating a turn signal lamp (e.g., turn signal lamps 102, 104, 106 and 108) of motor vehicle 50. System 100 comprises a navigation system 115, a turn signal indicator 120, and a turn signal lamp activator 125 each coupled to one another and to turn signal lamps 102, 104, 106 and 108 via a bus 130 (e.g., a wired and/or wireless bus).

Navigation system 115 is a turn-by-turn navigation system. That is, navigation system 115 is configured to receive inputs (e.g., a starting point and a destination, or just a destination) and to determine/calculate a route from the starting point to the destination or from the present location of motor vehicle 50 to the destination. Accordingly, navigation system 115 may include any firmware, hardware, and/or software capable of generating/calculating a route including one or more turns to a destination by means of, for example, global positioning or other navigation techniques.

Navigation system 115 is also configured to track the progress of motor vehicle 50 as it follows a route generated by navigation system 115. In addition, navigation system 115 is configured to activate (via bus 130) turn signal lamps 102 and 104 or turn signal lamps 106 and 108 when motor vehicle 50 approaches a turn. Specifically, navigation system 115 is configured to activate turn signal lamps 102 and 104 each time motor vehicle 50 approaches a left turn, and activate turn signal lamps 106 and 108 each time motor vehicle 50 approaches a right turn. That is, turn signal lamps 102 and 104 or turn signal lamps 106 and 108 are automatically activated prior to motor vehicle 50 reaching each turn without driver involvement (i.e., turn signal lamps 102, 104, 106 and 108 are automatically activated by navigation system 115).

In one exemplary embodiment, navigation system 115 activates turn signal lamps 102 and 104 or turn signal lamps 106 and 108 when motor vehicle is a predetermined distance from a left or right turn, respectively. The predetermined distance may be any distance that provides adequate notification to other drivers or pedestrians; however, the predetermined distance should not be less than and/or greater than any minimum and/or maximum distances prescribed by the law of the jurisdiction where motor vehicle 50 is operating.

In another exemplary embodiment, navigation system 115 activates turn signal lamps 102 and 104 or turn signal lamps 106 and 108 when motor vehicle is an estimated predetermined time from a turn. Specifically, navigation system 115 is configured to calculate the distance between the present location of motor vehicle 50 and a turn then divide this distance by the present rate of speed of motor vehicle 50 to calculate an estimate of the time it will take motor vehicle 50 to reach the turn. The estimated time may include an additional amount of time to account for vehicle braking time prior to reaching the turn. The additional time may be variable depending on the present speed of motor vehicle 50 at the time of calculation or may be a predetermined amount of time (e.g., in the range of about 10 seconds to about 30 seconds). The estimated predetermined time is sufficient to provide adequate notification to other drivers or pedestrians. In either situation the predetermined distance and/or time should comply with the law of the jurisdiction where motor vehicle 50 is operating.

In one embodiment, navigation system is configured to de-activate turn signal lamps 102 and 104 or turn signal lamps 106 and 108 if motor vehicle 50 fails to engage a turn on the route. That is, if the driver misses a turn, navigation system 115 automatically turns OFF turn signal lamps 102 and 104 or turn signal lamps 106 and 108, as the case may be, at a predetermined distance (or time) after it is determined that motor vehicle 50 has failed to engage the turn. Moreover, navigation system 115 is configured to continue to activate turn signal lamps 102 and 104 or turn signal lamps 106 and 108 when motor vehicle returns to the calculated route after one or more turns have been missed.

Navigation system 115 is also configured to activate turn signal indicator 120 each time navigation system 115 activates turn signal lamps 102 and 104 or turn signal lamps 106 and 108. Turn signal indicator 120 may be any device, hardware, and/or software capable or providing visual and/or audible cues indicating a left turn or a right turn to a driver of motor vehicle 50.

Turn signal indicator 120 may be integrated on the instrument panel of motor vehicle 50; however, turn signal indicator 120 may be located at other locations on/in motor vehicle 50 detectable by the driver to alert the driver that a turn is coming in the near future. Furthermore, in conventional motor vehicles, turn signal indicator 120 typically provides a flashing green arrow pointing to the left indicating activation of turn signal lamps 102 and 104 and a flashing green arrow pointing to the right indicating activation of turn signal lamps 106 and 108. Moreover, turn signal indicator 120 also provides an intermittent “clicking” sound coordinated with each flash of the respective arrows. Various embodiments of the present invention contemplate the use of turn signal indicator 120 discussed above when navigation system 115 activates turn signal lamps 102 and 104 or turn signal lamps 106 and 108.

In accordance with one exemplary embodiment, turn signal indicator 120 is configured to provide a first type of indication when navigation system 115 activates turn signal lamps 102 and 104 or turn signal lamps 106 and 108, and a second type of indication when the driver activates turn signal lamps 102 and 104 or turn signal lamps 106 and 108. That is, turn signal indicator 120 is configured to provide different visual cues and/or different audible cues when turn signal lamps 102 and 104 or turn signal lamps 106 and 108 have been automatically or manually activated; i.e., turn signal indicators may include different colors, flash rates, sizes, brightness, and the like for the arrows or may comprises indicators of different shapes when turn signal lamps 102 and 104 or turn signal lamps 106 and 108 are activated by navigation system 115 as opposed to being the result of manual activation. Likewise, turn signal indicators may include different sounds, sound rates, magnitudes, and the like when turn signal lamps 102 and 104 or turn signal lamps 106 and 108 are activated by navigation system 115 as opposed to manually activated.

For example, turn signal indicator 120 may provide the known visual and audible cues associated with the arrows in contemporary motor vehicles when turn signal lamps 102 and 104 or turn signal lamps 106 and 108 are manually activated, but may provide red arrows with a faster or slower flash rate and a louder or quieter “clicking” sound when turn signal lamps 102 and 104 or turn signal lamps 106 and 108 are activated by navigation system 115. Various embodiments contemplate the numerous combinations of different visual and/or audible cues even though each is not specifically mentioned.

Turn signal lamp activator 125 may be any device, hardware, and/or software capable of activating turn signal lamps 102 and 104 or turn signal lamps 106 and 108. Typically, turn signal lamp activator 125 is a lever protruding laterally from the steering column that activates turn signal lamps 102 and 104 when pushed down and activates turn signal lamps 106 and 108 when pushed up.

In one embodiment, turn signal lamp activator 125 is not activated (i.e., not pushed up or down) when navigation system 115 has activated turn signal lamps 102 and 104 or turn signal lamps 106 and 108. In this embodiment, turn signal lamp activator comprises a button, switch, knob, or the like for manually de-activating turn signal lamps 102 and 104 or turn signal lamps 106 and 108 when they have been activated by navigation system 115. In another embodiment, turn signal lamp activator 125 is activated (i.e., pushed up or down) by navigation system 115 when navigation system 115 activates turn signal lamps 102 and 104 or turn signal lamps 106 and 108. In this embodiment, the driver may manually turn OFF turn signal lamps 102 and 104 or turn signal lamps 106 and 108 by returning turn signal lamp activator 125 to the neutral or OFF position.

Furthermore, if the driver manually activates turn signal lamps 102 and 104 or turn signal lamps 106 and 108 (e.g., via turn signal lamp activator 125) prior to navigation system 115 activating turn signal lamps 102 and 104 or turn signal lamps 106 and 108, the automatic activation of turn signal lamps 102, 104, 106, and 108 is bypassed. That is, manual activation of turn signal lamps 102 and 104 or turn signal lamps 106 and 108 overrides automatic activation of turn signal lamps 102 and 104 or turn signal lamps 106 and 108 by navigation system 115.

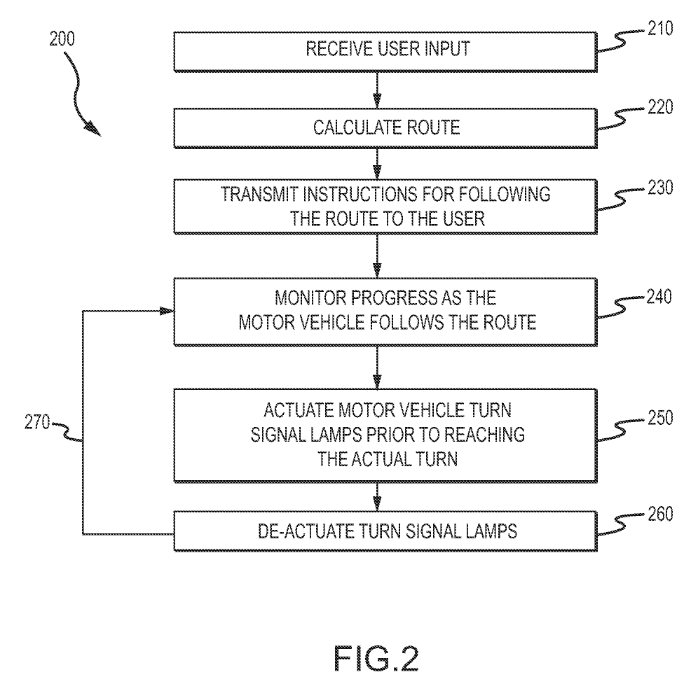

FIG. 2 is a flow diagram of one exemplary embodiment of a method 200 for automatically activating a turn signal lamp (e.g., turn signal lamps 102 and 104 or turn signal lamps 106 and 108 of FIG. 1) on a motor vehicle (e.g., motor vehicle 50 of FIG. 1). Method 200 begins when a navigation system (e.g., navigation system 115 of FIG. 1) receives an input from a user (step 210). Appropriate inputs include a starting point and a destination or just a destination.

After the input has been received, a route (including at least one turn) from the starting point to the destination or from the present location of motor vehicle 50 to the destination is determined/calculated (step 220). The route is then visually and/or audibly transmitted to the user (step 230). The progress of motor vehicle 50 is monitored as the driver follows the route (step 240).

When motor vehicle 50 approaches a turn along the route, turn signal lamps 102 and 104 or turn signal lamps 106 and 108 are automatically activated prior to motor vehicle 50 reaching the actual turn (step 250). Turn signal lamps 102 and 104 or turn signal lamps 106 and 108 may be activated a predetermined distance and/or an estimated predetermined amount of time prior to motor vehicle 50 actually reaching the turn, as explained above with reference to FIG. 1.

After motor vehicle 50 navigates the turn, turn signal lamps 102 and 104 or turn signal lamps 106 and 108 are de-activated (step 260). In one embodiment, de-activation occurs automatically by navigation system 115 or the motion of the steering wheel of motor vehicle 50 returning to the neutral position, or manually by the driver when the turn is completed. In another embodiment, de-activation occurs automatically when the driver misses a turn. In this embodiment, turn signal lamps 102 and 104 or turn signal lamps 106 and 108 are de-activated a predetermined distance and/or time after the driver has missed the turn.

Method 200 then returns to step 240 to continue to monitor the progress of motor vehicle 50 (step 270). Steps 240-270 are then repeated as needed until the destination is reached.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

I claim:

1. A motor vehicle, comprising:
a turn signal; and
a navigation system coupled to the turn signal, the navigation system configured to:
determine a route to a destination, the route having a turn,
monitor a present position of the motor vehicle, and
automatically activate the turn signal when the motor vehicle approaches the turn.

2. The motor vehicle of claim 1, wherein the navigation system is further configured to activate the turn signal when the motor vehicle is a predetermined distance from the turn.

3. The motor vehicle of claim 1, wherein the navigation system is further configured to activate the turn signal when the motor vehicle is an estimated time from the turn.

4. The motor vehicle of claim 1, further comprising a turn signal activator coupled to the turn signal, the turn signal activator comprising means for de-activating the turn signal when the navigation system has activated the turn signal.

5. The motor vehicle of claim 1, further comprising a turn signal indicator coupled to the navigation system, the turn signal indicator configured to provide:
a first indication when the turn signal indicator has been activated by the navigation system, and
a second indication when the turn signal indicator has been manually activated.

6. The motor vehicle of claim 5, wherein the first indication and second indication are different visual cues or different audible cues.

7. The motor vehicle of claim 5, wherein the first indication and second indication are different visual cues and different audible cues.

8. The motor vehicle of claim 1, wherein the navigation system is further configured to:
determine if the motor vehicle entered the turn; and
automatically de-activate the turn signal if the motor vehicle has failed to enter the turn.

9. A navigation system configured to be coupled to a turn signal of a motor vehicle, the navigation system comprising:
means for receiving a destination from a user;
means for generating a route to the destination, the route having a turn; and
means for activating the turn signal coupled to the generating means, the activating means configured to automatically activate the turn signal when the motor vehicle approaches the turn.

10. The navigation system of claim 9, further comprising means for determining a distance the motor vehicle is away from the turn coupled to the activating means, wherein the activating means comprises means for activating the turn signal when the motor vehicle is one of a predetermined distance and a predetermined estimated time from the turn.

11. The navigation system of claim 9, further comprising means for automatically de-activating the turn signal if the motor vehicle fails to engage the turn.

12. The navigation system of claim 9, further comprising means for notifying a user that the turn signal has been activated, the notifying means configured to provide a first indication when the activating means automatically activates the turn signal and a second indication when the user activates the turn signal.

13. The navigation system of claim 12, wherein the first indication and second indication are different visual cues or different audible cues

14. A method for automatically activating a turn signal on a motor vehicle, the method comprising the steps of:
determining a route to a destination for the motor vehicle, the route having a turn;
monitoring a present location of the motor vehicle; and
automatically activating the turn signal when the motor vehicle approaches the turn.

15. The method of claim 14, wherein the automatically activating step comprises the step of automatically activating the turn signal when the motor vehicle is within a predetermined distance of the turn.

16. The method of claim 14, wherein the automatically activating step comprises the step of automatically activating the turn signal when the motor vehicle is within a predetermined time of reaching the turn.

17. The method of claim 14, further comprising the steps of:
transmitting a first indication to a user when the turn signal has been automatically activated; and
transmitting a second indication to the user when the turn signal has been manually activated.

18. The method of claim 16, wherein the first indication and the second indication comprise different visual cues or different audible cues.

19. The method of claim 18, wherein the first indication and the second indication comprise different visual cues and different audible cues.

20. The method of claim 14, further comprising the step of automatically de-activating the turn signal if the motor vehicle fails to enter the turn.
